(19) United States
(12) Patent Application Publication
(10) Pub. No.: US 2018/0225418 A1
(43) Pub. Date: Aug. 9, 2018

(54) AUTOMATED ENVIRONMENT ADJUSTMENT DEVICE

(71) Applicant: INTERNATIONAL BUSINESS MACHINES CORPORATION, ARMONK, NY (US)

(72) Inventors: STEPHEN A. CARRAWAY, DURHAM, NC (US); JAMES P. EBERWEIN, RALEIGH, NC (US); VIVEK GROVER, CARY, NC (US); DANIEL B. WILLIS, RALEIGH, NC (US)

(21) Appl. No.: 15/428,245

(22) Filed: Feb. 9, 2017

(51) Int. Cl. G06F 19/00; G10L 17/08

(52) U.S. Cl. CPC G06F 19/322; G10L 15/1822; G10L 17/08; G06F 19/326

(57) ABSTRACT

In response to detecting speech data within an environment encompassing a person, computer processors configured by aspects of the present invention identify a presentment of advisory healthcare content to the person within the detected speech data. In response to identifying the presentment of the advisory healthcare content, the processors determine whether the person is oriented to time and place. In response to determining that the person is not oriented to time and place, the processors iteratively change environmental attributes of the environment encompassing the person to present stimuli that are likely to instigate a corresponding improvement in the orientation to time and place of the person, until determining an improvement in the orientation to time and place of the person, wherein the processors instigate another, second presentation of the identified healthcare content to the patient.

### BACKGROUND

Patients relocated from their familiar surroundings to a clinical or hospital setting or location may experience disorientation as to time and place, sometimes referred to as “hospital delirium.” This is commonly experienced by patients waking from sedation under general anesthetic. Patients may be reoriented over time by attendants or family members, via conveying information informing the patient as to their current location and time, and providing other contextual information. For example, by describing to a patient a procedure they experienced while under sedation, describing how long they were under sedation, informing them of their current location and the current time, how long they have been here, etc.

Some patients experience heightened disorientation effects that are not quickly or easily dispersed via verbally conveyed information. The extent or severity of the disorientation may be influenced by a wide variety of factors. For example, patients recovering from significant or extensive surgical procedures may suffer from severe pain or physical discomfort, or changes or variation in blood pressure and oxygen levels beyond normal levels, leading to states of confusion or disorientation not readily amenable to dissipation through discussions with the patient. Such states of confusion and disorientation may negatively impact the patient, leading to longer recovery times that necessitate prolonged hospital stays and proportionate increases in exposure risk to infectious agents present within hospital environments. In some situations, the environment of the hospital is itself disorienting to the patient, and accordingly such a prolonged stay may worsen, rather than help obviate, a patient's delirium state.

### BRIEF SUMMARY

In one aspect of the present invention, a computerized method for selecting and presenting environmental stimulus to a person in response to real-time orientation assessment includes executing steps on a computer processor. Thus, in response to detecting speech data within an environment encompassing a person, a computer processor identifies a first presentment of advisory healthcare content to the person within a first portion of the detected speech data that is relevant to care of the person. In response to identifying the first presentment of advisory healthcare content, the processor determines whether the person is oriented to time and place. In response to determining that the person is not oriented to time and place, the processor iteratively changes an environmental attribute of the environment encompassing the person to present stimuli that is likely to instigate a corresponding improvement in the orientation to time and place of the person, until determining an improvement in the orientation to time and place of the person, wherein the processor instigates another, second presentation of the identified healthcare content to the patient.

In another aspect, a system has a hardware processor in circuit communication with a computer readable memory and a computer-readable storage medium having program instructions stored thereon. The processor executes the program instructions stored on the computer-readable storage medium via the computer readable memory and is thereby configured to, in response to detecting speech data within an environment encompassing a person, identify a first presentment of advisory healthcare content to the person within a first portion of the detected speech data that is relevant to care of the person. In response to identifying the first presentment of advisory healthcare content, the processor determines whether the person is oriented to time and place. In response to determining that the person is not oriented to time and place, the processor iteratively changes an environmental attribute of the environment encompassing the person to present stimuli that is likely to instigate a corresponding improvement in the orientation to time and place of the person, until determining an improvement in the orientation to time and place of the person, wherein the processor instigates another, second presentation of the identified healthcare content to the patient.

In another aspect, a computer program product for selecting and presenting environmental stimulus to a person in response to real-time orientation assessment has a computer-readable storage medium with computer readable program code embodied therewith. The computer readable hardware medium is not a transitory signal per se. The computer readable program code includes instructions for execution which cause the processor to, in response to detecting speech data within an environment encompassing a person, a computer processor identifies a first presentment of advisory healthcare content to the person within a first portion of the detected speech data that is relevant to care of the person. The processor is configured to determine whether the person is oriented to time and place in response to identifying the first presentment of advisory healthcare content. In response to determining that the person is not oriented to time and place, the processor iteratively changes an environmental attribute of the environment encompassing the person to present stimuli that is likely to instigate a corresponding improvement in the orientation to time and place of the person, until determining an improvement in the orientation to time and place of the person, wherein the processor instigates another, second presentation of the identified healthcare content to the patient.

### BRIEF DESCRIPTION OF THE DRAWINGS

These and other features of embodiments of the present invention will be more readily understood from the following detailed description of the various aspects of the invention taken in conjunction with the accompanying drawings in which:

FIG. 1 depicts a cloud computing environment according to an embodiment of the present invention.

FIG. 2 depicts abstraction model layers according to an embodiment of the present invention.

FIG. 3 depicts a computerized aspect according to an embodiment of the present invention.

FIG. 4 is a flow chart illustration of an embodiment of the present invention.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

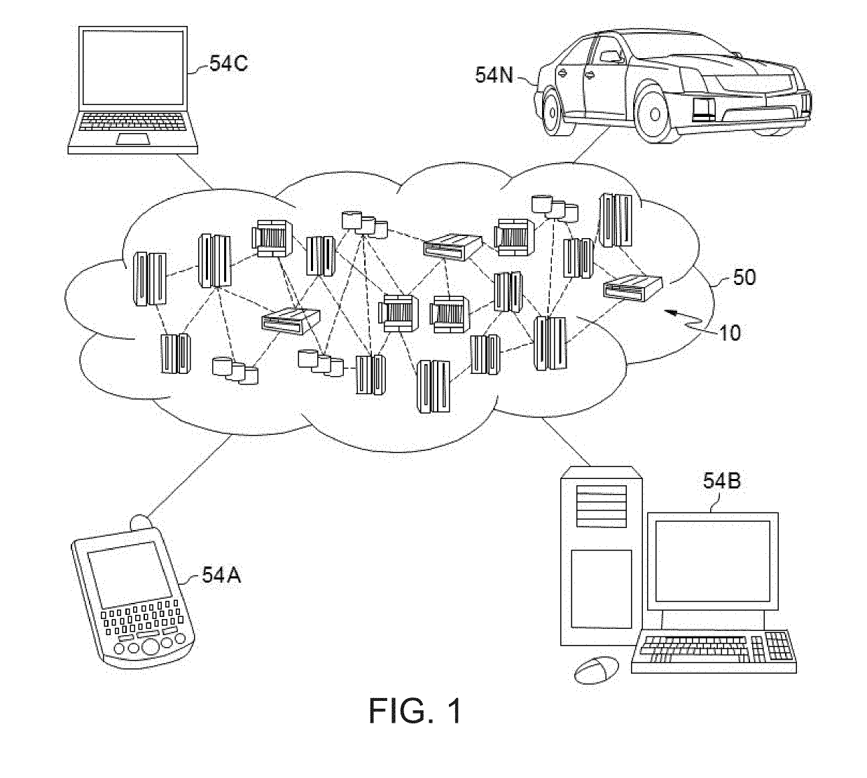

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

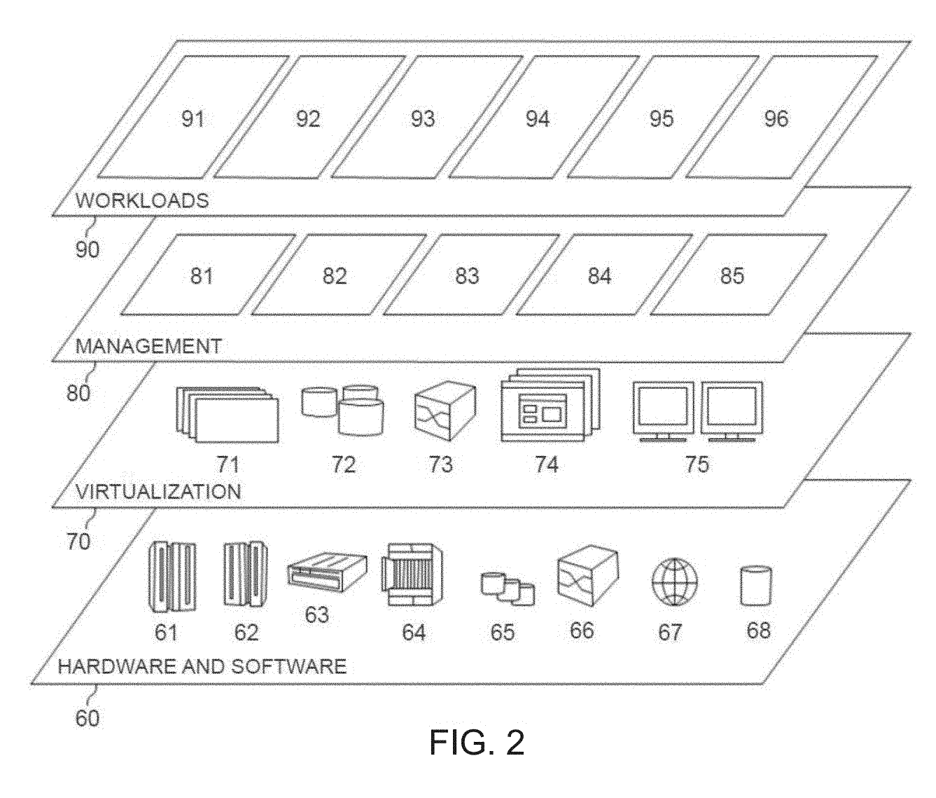

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and processing for selecting and presenting environmental stimulus to a person in response to real-time orientation assessment 96.

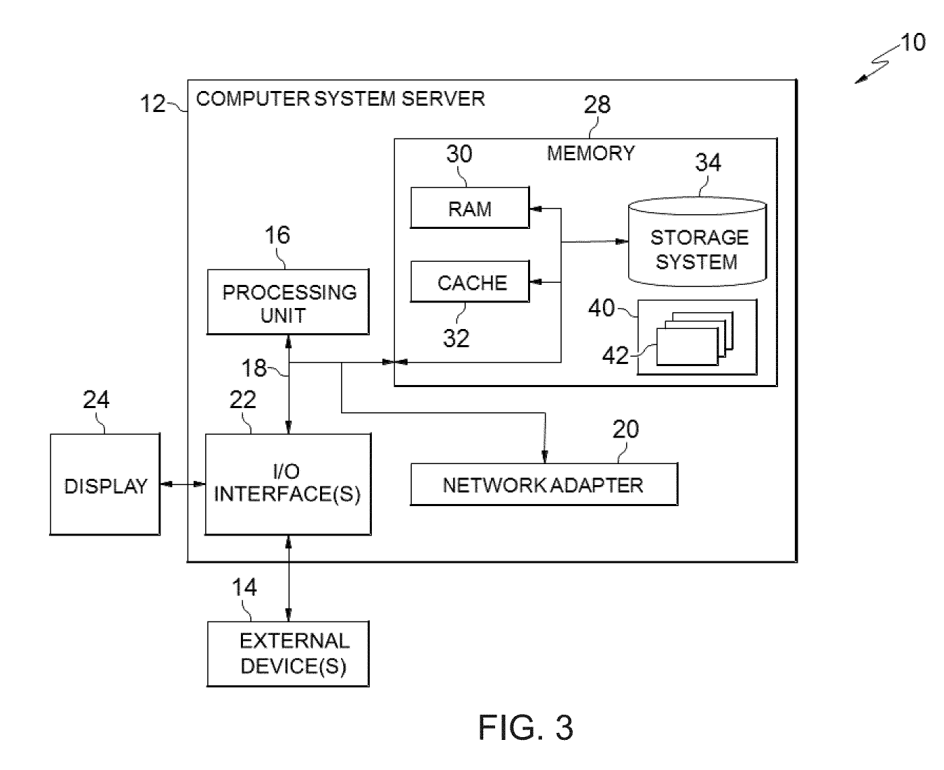

FIG. 3 is a schematic of an example of a programmable device implementation 10 according to an aspect of the present invention, which may function as a cloud computing node within the cloud computing environment of FIG. 2. Programmable device implementation 10 is only one example of a suitable implementation and is not intended to suggest any limitation as to the scope of use or functionality of embodiments of the invention described herein. Regardless, programmable device implementation 10 is capable of being implemented and/or performing any of the functionality set forth hereinabove.

A computer system/server 12 is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

The computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

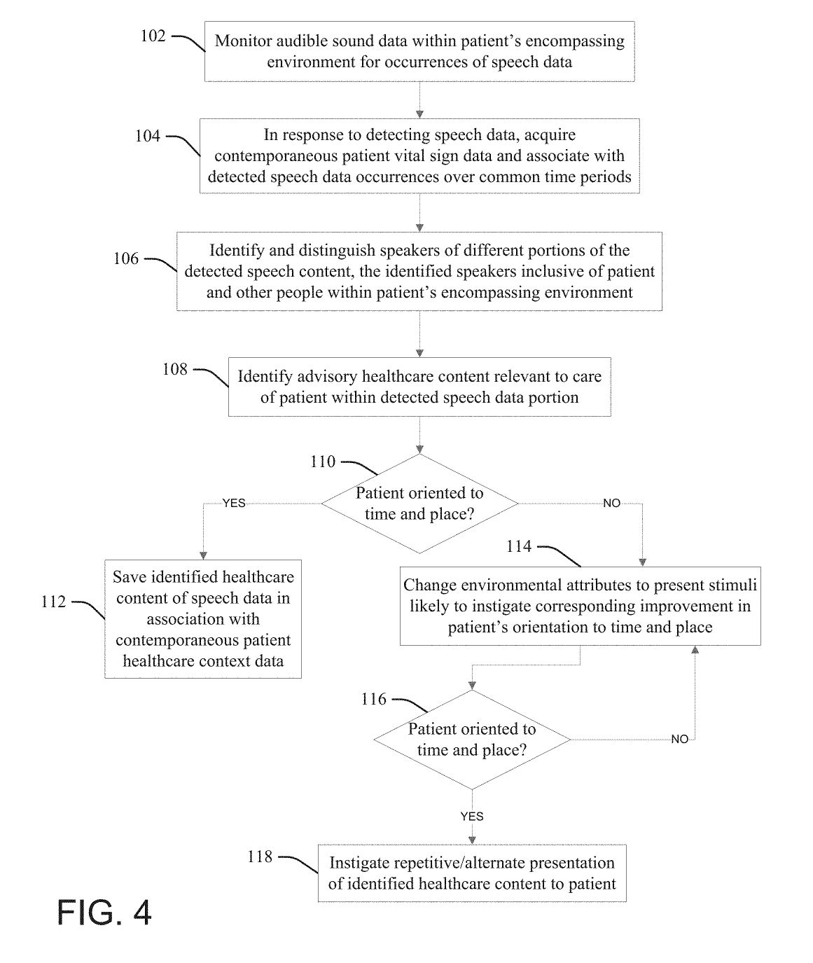

FIG. 4 illustrates a process or system according to the present invention that selects and presents environmental stimulus in a patient room (or other environment) in response to real-time patient assessment. At 102 a processor that is configured according to an aspect of the present invention (the “configured processor”) monitors the immediate, encompassing environment (room, proximate area, etc.) of a patient for speech data. The configured processor may be implemented in accordance with the computer system server 10 of FIG. 3, including as the cloud node 10 of FIG. 1, as described respectively above.

Thus, at 102 the configured processor monitors sound data picked up by microphone devices within the room to detect occurrences of speech data within the audible sound data within the patient environment, for example applying signal and filter processing to the sound data to identify sound waves that match speech profile waves in amplitude and waveform.

At 104, in response to detecting speech data within the room sound data, the configured processor acquires contemporaneous patient vital sign data (vital sign data occurring at the same time as the detected speech data) and associates the vital sign data to the detected speech data over the common time periods. Illustrative but not exhaustive examples of vital sign data include heart and respiration rates, oxygen levels, electrocardiogram, encephalogram, body temperature, blood pressure, voice metrics (strength, volume, pitch, rate, etc.), and still other appropriate data will be chosen my one skilled in the art.

At 106 the configured processor identifies speakers of portions of the detected speech content, and in particular to distinguish speech data of the patient (as a first speaker) from speech data of other people within the room (doctors, nurses, social workers, family members, etc.). The identification may be through a variety of means, and illustrative but not limiting or exhaustive examples include applying natural language processing to the detected speech data to identify discrete phrasing; comparing sound profiles of different phrases for differences in voice metrics (strength, volume, pitch, rate, etc.) indicative of different speakers; correlating locations of origins of the phrases within a room to determined locations of speakers identified by badge or ID that broadcasts the identity of the speaker; matching distinguished voice data profiles to stored voice profiles for known service providers, such as specific health care providers employed by the health facility in which the room is located, or to some other corpus or database of known (registered, etc.) health care service providers; receiving identification indicia broadcast (or unicast) to the configured processor (via a network port), such as from a central server that tracks healthcare service provider locations (via smart phones or tablets carried thereby) and reports the locations to the configured processor for correlation with speech data acquired from the sound data in the monitored room; and still other examples will be apparent to one skilled in the art.

At 108 the configured processor identifies advisory healthcare content within the detected speech data portions that is associated with (for example, directed to) and relevant to the patient. Identification at 108 may comprehend applying natural language processing to the detected speech data portions identified (associated) with the respective patient and other speakers to (comprehend, determine, etc.) advisory healthcare content within the speech portions that is relevant to the patient. Thus, the configured processor may effectively parse the speech content to identify healthcare provider instruction phrases directed to the patient, or repeated or asked by the patient, such as “take medicine A every four hours,” “blood pressure above value X,” “dietary restrictions,” “no green vegetables,” “stop taking your daily multivitamin while on this medication,” etc. Such identification may be a function of the associated speaker identity, for example, giving higher weight or probabilities to determination of healthcare relevance to speech from a speaker identified as a healthcare service provider (doctor, nurses, therapist, social worker) relative to another speaker identified as a family member, or as the patient.

The determination of advisory healthcare content at 108 may also be in response to inputs received from healthcare providers. For example, a flag or marker input entered via a tablet or smart phone, or a key phrase specifically stated by a speaker (for example, “Attention, this a medication instruction . . . ”) may be recognized by the configured processor, and accordingly the contemporaneous speech content from the speaker is identified as a healthcare directive or instruction.

In response to identifying healthcare content within the speech portions of the second speakers at 108, at 110 the configured processor determines whether the patient is (likely) oriented to time and place (and thereby likely capable of understanding, processing, retaining, etc. the identified healthcare content) or is instead (likely) disoriented to time and place (and thereby corresponding unlikely to be capable of understanding, processing, retaining, etc. the identified healthcare content).

The orientation determination at 110 may be determined from parsing speech content of the patient. For example, aspects may determine that the patient is likely disoriented to time and space in response to a mismatch in patient speech content to the speech content of other speakers, such as between patient answers identified via applying natural language processing to a (second) portion of the detected speech data that is immediately subsequent to questions posed within a prior (first) portion of the detected speech data from another person. Mismatches may also be detected in response to a failure to repeat instructions accurately as related to the patient by another speaker, and still other examples will be apparent to one skilled in the art.

The orientation determination at 110 may also be a function of the patient's healthcare data context, as indicated by one or more of current vital sign data contemporaneous to (at the time of) the identified healthcare content, patient history data, including data indicative of type of procedure patient is recovering from, elapsed time since procedure was completed, treatment plan patient is on, medication they are taking, along with known or likely side effects determined as function of age and weight and other relevant demographics and medical history, etc. Thus, determination of a likelihood of orientation or disorientation at 110 may be function of comparing the patient healthcare data context to norms established by other patients, or by the history of the patient, including by matching the current patient context data to historic data patterns wherein other patients, or this patient historically, were either oriented or disoriented under similar healthcare context conditions. Thus, aspects of the present invention determine oriented or disoriented conditions by correlation to similar, historic data and analysis with respect to the same patient, or to other patients with similar conditions, treatment plans, etc.

If determined at 110 that the patient is likely oriented to time and place, at 112 the configured processor records (saves) the identified healthcare content of the speech data in association with said contemporaneous patient healthcare context data (vital signs, medical procedure history, etc.). Thus, the content is available for retrieval by the patient as needed in the future, for example after discharge from the facility room, to confirm their understanding of any instructions therein; or by healthcare providers, to establish the likelihood that the patient understood directions within the healthcare content.

Else, if determined at 110 that the patient is likely disoriented to time and place, at 114 and the configured processor iteratively changes environmental attributes of the room to present stimuli that are likely to instigate a corresponding improvement in the patient's orientation to time and place, and reassesses the patient's orientation at 116 (including by one or more of the analyses described above with respect to 110, for example as indicated by real-time analysis of vital sign data, or from speech content of the patient that indicates an improved orientation to time and place, for example, affirmative statements indicating that the patient is oriented to current time and place, etc.) until determined that the patient is now likely oriented to time and place as a function of current contextual healthcare data for the patient, wherein at 118 the configured processor instigates another (repetitive or alternate) presentation of the identified healthcare content to the patient (for example, signaling the healthcare provider/second speaker to repeat the content, or playing back recorded audio of the first presentation to the patient, or publishing a text data transcription of the identified healthcare content to the patient, etc.)

Thus, the steps or processes 114 and 116 iteratively repeat in a bio-feedback process wherein the patient's vital signs are continually compared in real-time to normal and historic data applicable to the patient. The patient's room environment is thereby iteratively adjusted to present different air temperature, lighting, sounds and soundscapes, imagery (via still photo and video presentations) that are soothing, calming, therapeutic or familiar to the patient, to help place the patient in a healthcare context that is more likely to orient the patient to time and place. The stimuli presented at 114 may trigger memories associated with familiar inputs that provide cues to the patient as to time and place, or provide a calming, soothing environment that brings vital sign data back into beneficial ranges, thereby helping the cognitive ability of the patient to reorient him or herself to current time and place.

Aspects thereby generate a virtual, smart patient hospital room environment that dynamically presents to the patient images (pictures of loved ones, favorite vacation memories, etc.), videos (for example, known or favorite television programs), sounds (music, pleasing or familiar sounds from the natural world recognizable to the patient, etc.), or creates a beneficial ambience via light, music and sound stimuli, window transparency settings (blinds closed or open, etc.), positioning of a patient's bed (for example, selecting an appropriate incline or firmness setting), driving pressure socks or other devices to adjust blood pressure and circulation attributes, etc., to improve the cognitive ability of the patient to comprehend conversation content from doctors, nurse commands.

Aspects use patient vital sign data in real-time to establish a bio-feedback mood profile that captures mood swings and changes in attitude and sentiments, including as a function of behavioral data captured from camera and sound data of the patient that is indicative of patient moods and preferences, etc. Stimuli may be revised, selected and presented on a moment-by-moment basis, to discern inputs that alter the patient's state of mind to create a virtual environment or ambience that is more conducive to patient's good health, speedy recovery, or to prevent a transition of the patient from an oriented state into a state of delirium.

Thus, aspects may automatically adjust mechanical bed settings appropriately (selecting between different incline or decline positions, mattress firmness, therapeutic vibration settings), or otherwise target environmental surroundings attributes to pro-actively prevent a patient from progressing toward hospital delirium and assist in establishing a healthy state of mind for patients admitted in hospitals. Aspects may create a lively virtual ambience conducive to patient's health, based on pre-fed algorithms and integrated artificial intelligence tools and processes.

Aspects may also change room environmental settings in response to real-time data determinations from interactions with the patient, trying different settings and inputs until the bio-feedback indicates an improvement in the patient's vital signs or orientation as to time and place (as determined by analyzing patient speech content, or determining performance on automated test questions, etc.). “Virtual rooms” thus configured by processes and systems according to the present invention collect and analyze data over time and dynamically perform actions, inclusive of processing instructions from the patient, doctors, family members, staff, etc., or giving direction or instructions to the patient or caregiver to take action in response to determined states of the patient (for example, noting that blood pressure is rising, and that removing certain speakers from the room in the past has helped to lower the patient blood pressure.

In addition to bio feedback, aspects select and present environmental attributes and stimuli in response to other physiological inputs, including behavioral change observations entered by healthcare professionals as inputs. Aspects analyze conversation content, data indicative of patient mood swings, recommendations from physicians, reactions to medications or specific ambient light, temperature, and humidity attributes of the patient's encompassing environment to take an appropriate action.

The terminology used herein is for describing particular aspects only and is not intended to be limiting of the invention. As used herein, the singular forms “a”, “an” and “the” are intended to include the plural forms as well, unless the context clearly indicates otherwise. It will be further understood that the terms “include” and “including” when used in this specification specify the presence of stated features, integers, steps, operations, elements, and/or components, but do not preclude the presence or addition of one or more other features, integers, steps, operations, elements, components, and/or groups thereof. Certain examples and elements described in the present specification, including in the claims, and as illustrated in the figures, may be distinguished, or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations, or process steps.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for selecting and presenting environmental stimulus to a person in response to real-time orientation assessment, comprising executing on a computer processor the steps of:
in response to detecting speech data within an environment encompassing a person, identifying a first presentment of advisory healthcare content to the person within a first portion of the detected speech data that is relevant to care of the person;
in response to identifying the first presentment of advisory healthcare content, determining whether the person is oriented to time and place;
in response to determining that the person is not oriented to time and place, iteratively changing an environmental attribute of the environment encompassing the person to present stimuli that is likely to instigate a corresponding improvement in the orientation to time and place of the person, until determining an improvement in the orientation to time and place of the person; and
in response to determining the improvement in the orientation to time and place of the person, instigating another, second presentation of the identified healthcare content to the patient.

2. The method of claim 1, wherein the stimuli that is likely to instigate a corresponding improvement in the orientation to time and place of the person is selected from the group consisting of revising an air temperature of the environment encompassing the person, presenting a different lighting illumination level, and presenting a sound or image item to the person that is likely to be one of soothing, calming, therapeutic or familiar to the patient.

3. The method of claim 1, further comprising:
determining whether the person is oriented to time and place as a function of a healthcare data context of the person that is selected from the group consisting of contemporaneous vital sign data for the person occurring at a same time as the first portion of the detected speech data, a type of procedure that the person is recovering from, an elapsed time since the procedure was completed, a treatment plan for the person, medication that the person is taking, and likely side effects of the medication determined as a function of demographic data of the person and medical history of the person.

4. The method of claim 3, wherein the step of determining whether the person is oriented to time and place is a function of matching the healthcare data context of the person to a norm established by patient history data.

5. The method of claim 3, further comprising:
in response to identifying the first presentment of advisory healthcare content, acquiring the contemporaneous vital sign data for the person occurring at the same time as the first portion of the detected speech data;
associating the contemporaneous vital sign data to the first portion of the detected speech data over a common time period; and
determining whether the person is oriented to time and place as a function of the acquired contemporaneous vital sign data.

6. The method of claim 5, wherein the vital sign data is selected from the group consisting of a heart rate, a respiration rate, an oxygen level, electrocardiogram data, encephalogram data, a body temperature, a blood pressure value, a voice strength, a voice volume, a voice pitch, and a voice rate.

7. The method of claim 1, further comprising:
identifying the advisory healthcare content that is relevant to the care of the person within the first portion of the detected speech data by:
applying natural language processing to the first portion of the detected speech data to parse speech content within the first portion of the detected speech data; and
identifying a healthcare provider instruction phrase that is directed to the patient within the parsed speech content of the first portion of the detected speech data.

8. The method of claim 7, further comprising:
identifying the person as a speaker of a second portion of the detected speech data that is immediately subsequent to the first portion of the detected speech data; and
determining whether the person is oriented to time and place by:
applying natural language processing to the second portion of the detected speech data to parse speech content within the second portion of the detected speech data; and
determining that the person is likely disoriented to time and space in response to a mismatch in the parsed speech content of the second portion of the detected speech data to the parsed speech content of the first portion of the detected speech data.

9. The method of claim 7, further comprising:
identifying a speaker of the first portion of the detected speech data as a healthcare provider; and
identifying the first presentment of advisory healthcare content within the first portion of the detected speech data as a function of identifying the speaker of the first portion of the detected speech data as a healthcare provider.

10. The method of claim 9, further comprising:
identifying the speaker of the first portion of the detected speech data as a healthcare provider by a process selected from the group consisting of:
correlating a location of origin of the first portion of the detected speech data to a determined location of an identity of the speaker; and
matching a voice data profile of the speaker to a stored voice data profile of a known service provider.

11. The method of claim 1, further comprising:
integrating computer-readable program code into a computer system comprising a processor, a computer readable memory in circuit communication with the processor, and a computer readable storage medium in circuit communication with the processor; and
wherein the processor executes program code instructions stored on the computer-readable storage medium via the computer readable memory and thereby performs the steps of identifying the first presentment of advisory healthcare content to the person within the first portion of the detected speech data that is relevant to care of the person in response to detecting the speech data within the environment encompassing a person, determining whether the person is oriented to time and place in response to identifying the first presentment of advisory healthcare content, iteratively changing an environmental attribute of the environment encompassing the person to present stimuli that is likely to instigate a corresponding improvement in the orientation to time and place of the person until determining the improvement in the orientation to time and place of the person, and instigating the another, second presentation of the identified healthcare content to the patient in response to determining the improvement in the orientation to time and place of the person.

12. The method of claim 11, wherein the computer-readable program code is provided as a service in a cloud environment.

13. A system, comprising:
a processor;
a computer readable memory in circuit communication with the processor; and
a computer readable storage medium in circuit communication with the processor;
wherein the processor executes program instructions stored on the computer-readable storage medium via the computer readable memory and thereby:
in response to detecting speech data within an environment encompassing a person, identifies a first presentment of advisory healthcare content to the person within a first portion of the detected speech data that is relevant to care of the person;
in response to identifying the first presentment of advisory healthcare content, determines whether the person is oriented to time and place;
in response to determining that the person is not oriented to time and place, iteratively changes an environmental attribute of the environment encompassing the person to present stimuli that is likely to instigate a corresponding improvement in the orientation to time and place of the person, until determining an improvement in the orientation to time and place of the person; and
in response to determining the improvement in the orientation to time and place of the person, instigates another, second presentation of the identified healthcare content to the patient.

14. The system of claim 13, wherein the processor executes the program instructions stored on the computer-readable storage medium via the computer readable memory and thereby further:
determines whether the person is oriented to time and place as a function of a healthcare data context of the person that is selected from the group consisting of contemporaneous vital sign data for the person occurring at a same time as the first portion of the detected speech data, a type of procedure that the person is recovering from, an elapsed time since the procedure was completed, a treatment plan for the person, medication that the person is taking, and likely side effects of the medication determined as a function of demographic data of the person and medical history of the person.

15. The system of claim 14, wherein the processor executes the program instructions stored on the computer-readable storage medium via the computer readable memory and thereby determines whether the person is oriented to time and place is a function of matching the healthcare data context of the person to a norm established by patient history data.

16. The system of claim 14, wherein the processor executes the program instructions stored on the computer-readable storage medium via the computer readable memory and thereby further:
in response to identifying the first presentment of advisory healthcare content, acquires the contemporaneous vital sign data for the person occurring at the same time as the first portion of the detected speech data;
associates the contemporaneous vital sign data to the first portion of the detected speech data over a common time period; and
determines whether the person is oriented to time and place as a function of the acquired contemporaneous vital sign data.

17. The system of claim 14, wherein the processor executes the program instructions stored on the computer-readable storage medium via the computer readable memory and thereby further:
identifies the advisory healthcare content that is relevant to the care of the person within the first portion of the detected speech data by:
applying natural language processing to the first portion of the detected speech data to parse speech content within the first portion of the detected speech data; and
identifying a healthcare provider instruction phrase that is directed to the patient within the parsed speech content of the first portion of the detected speech data.

18. A computer program product for selecting and presenting environmental stimulus to a person in response to real-time orientation assessment, the computer program product comprising:
a computer readable storage medium having computer readable program code embodied therewith, wherein the computer readable storage medium is not a transitory signal per se, the computer readable program code comprising instructions for execution by a processor that cause the processor to:
in response to detecting speech data within an environment encompassing a person, identify a first presentment of advisory healthcare content to the person within a first portion of the detected speech data that is relevant to care of the person;
in response to identifying the first presentment of advisory healthcare content, determine whether the person is oriented to time and place;
in response to determining that the person is not oriented to time and place, iteratively change an environmental attribute of the environment encompassing the person to present stimuli that is likely to instigate a corresponding improvement in the orientation to time and place of the person, until determining an improvement in the orientation to time and place of the person; and
in response to determining the improvement in the orientation to time and place of the person, instigate another, second presentation of the identified healthcare content to the patient.

19. The computer program product of claim 18, wherein the computer readable program code instructions for execution by the processor further cause the processor to:
determine whether the person is oriented to time and place as a function of a healthcare data context of the person that is selected from the group consisting of contemporaneous vital sign data for the person occurring at a same time as the first portion of the detected speech data, a type of procedure that the person is recovering from, an elapsed time since the procedure was completed, a treatment plan for the person, medication that the person is taking, and likely side effects of the medication determined as a function of demographic data of the person and medical history of the person.

20. The computer program product of claim 18, wherein the computer readable program code instructions for execution by the processor further cause the processor to:
in response to identifying the first presentment of advisory healthcare content, acquire the contemporaneous vital sign data for the person occurring at the same time as the first portion of the detected speech data;
associate the contemporaneous vital sign data to the first portion of the detected speech data over a common time period; and
determine whether the person is oriented to time and place as a function of the acquired contemporaneous vital sign data.
